(19) United States
(12) Patent Application Publication
(10) Pub. No.: US 2009/0079842 A1
(43) Pub. Date: Mar. 26, 2009

(54) SYSTEM AND METHOD FOR IMAGE PROCESSING

(75) Inventor: Jeremy C. Wilson, Delta (CA)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL, INC., Morristown, NJ (US)

(21) Appl. No.: 11/861,970

(22) Filed: Sep. 26, 2007

(51) Int. Cl. H04N 5/228; H04N 5/76

(52) U.S. Cl. 348/222.1; 348/231.99

(57) ABSTRACT

An image processing system and method for recording the adjustment of the image during image stabilization. The system comprises an image capturing device for capturing an image and generating image data of the image, an image adjusting device for adjusting the image by processing the image data, and an image adjustment-recording device for recording the adjustment of the image implemented by the image adjusting device and generating at least one image attachment associated with the image and corresponding to the adjustment.

### BACKGROUND OF THE INVENTION

1. Field of the Invention

The present invention generally relates to a system and method for image processing, such as image stabilization. More particularly, this invention relates to a system and method for stabilizing images and recording adjustments made to images during the course of image stabilization.

2. Related Art

Image stabilization is the process of adjusting an image or video stream to correct image defects caused by camera shake. Image stabilization minimizes or prevents an image or video steam from becoming blurred due to camera shake. During the course of image stabilization, an image can be adjusted to compensate the image defects that result from camera shake. For example, the adjustment could be translation, rotation, zooming, shearing, and so on, more generally referred to in the art as an affine transformation.

However, problems can arise if the type and extent of the adjustment made to the image are not recorded in some fashion. For example, the adjustment process may inadvertently add shake to an image that is actually stable, or attempt to stabilize image motion that is not due to shake but due to an intentional camera motion, in which case it may be desirable to later correct this error to reverse the adjustment for forensic analysis of the image.

As a related example, when a recorded image is used for evidentiary purposes, it may be important to exactly know how the adjustment to the image was made by the system prior to recording. As a further example, shake can cause image blurring, but without an indication that the original image was shaking, the correlation between shake and image blur may not be obvious, so that the wrong approach may be taken to mitigate the blur issue.

Accordingly, there is a need for the image processing system and method to record the adjustment made during the course of image stabilization such that the type and extend of the adjustment can be tracked for subsequent actions, such as forensic analysis.

### SUMMARY OF THE INVENTION

In view of the foregoing and other problems of the conventional system and method, an object of the present invention is to provide an image processing system and method, which are capable of recording the image adjustment applied during image stabilization and generating an image attachment associated with the image and corresponding to the adjustment.

The present invention provides an image processing system that comprises an image capturing device for capturing an image and generating image data of the image, an image adjusting device for adjusting the image by processing the image data, and an image adjustment-recording device for recording the adjustment of the image implemented by the image adjusting device and generating at least one image attachment associated with the image and corresponding to the adjustment.

In one aspect of the system, the image attachment is a visual indicator overlaid on the adjusted image, indicating the type and extent of the image adjustment.

In another aspect of the system, the image attachment is metadata associated with the adjusted image, recording exactly the type and extent of the image adjustment. The metadata can also be utilized to control the analysis of the image adjustment. The system is also capable of optionally rendering a visual indicator by using the information in the metadata.

In yet another aspect of the system, the image attachment comprises both a visual indicator and metadata.

The present invention also provides an image processing method that comprises the steps of capturing an image and generating image data corresponding to the captured image, adjusting the captured image by processing the image data, and recording the adjustment of the image and generating an image attachment associated with the image and corresponding to the adjustment.

In one aspect of the method, a visual indicator overlaid on the adjusted image is generated as the image attachment, indicating the type and extent of the image adjustment.

In another aspect of the method, metadata associated with the adjusted image is generated as the image attachment, recording exactly the type and extent of the image adjustment. The metadata can be utilized to control the analysis of the image adjustment. The method also includes optionally rendering a visual indicator by using the information in the metadata.

### BRIEF DESCRIPTION OF THE DRAWINGS

These and other features, benefits and advantages of the present invention will become apparent by reference to the following text figures, with like reference numbers referring to like structures across the views, wherein:

FIG. 1 is a functional block diagram of an image processing system according to the present invention;

FIG. 2A-2C are flow charts illustrating an image processing method according to the present invention wherein an image attachment is generated to record the image adjustment, which could be a visual indicator, metadata or both;

FIG. 3a-3c are pictures showing a first embodiment of the visual indicator used by the present invention;

FIG. 4a-4c are pictures showing a second embodiment of the visual indicator used by the present invention; and

FIG. 5a-5c are pictures showing a third embodiment of the visual indicator used by the present invention.

### DETAILED DESCRIPTION OF THE INVENTION

The present invention now will be described in detail hereinafter with reference to the accompanying drawings, in which preferred embodiments of the invention are shown. However, this invention may be embodied in many different forms and should not be construed as limited to the embodiments set forth herein; rather, these embodiments are provided so that this disclosure will be thorough and complete, and will fully convey the scope of the invention to those skilled in the art. Like numerals refer to like elements throughout.

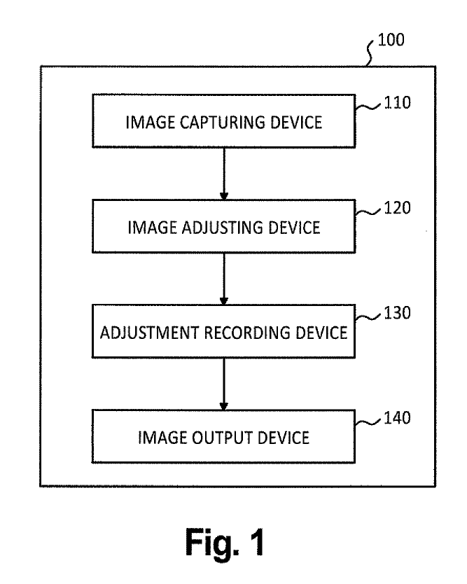

FIG. 1 illustrates the image processing system of the present invention, indicated by numeral 100. Image processing system 100 comprises an image capturing device 110, an image adjusting device 120, an image adjustment-recording device 130 and an image output device 140. Image capturing device 110 functions to capture an image of an object of interest and generate image data corresponding to the captured image. The image capturing device can be implemented by a variety of devices known in the art. For example, image capturing device 110 includes video surveillance cameras used in a video surveillance system. Such cameras typically provide analog or digital images via a cable to a secure location where the images are monitored by personnel and/or stored in memory for subsequent viewing and analysis. The image generated by the image capturing device could be a live image in real time, or a stored image in which case the image capturing device further includes an image storing device for storing the image data.

Image adjusting device 120 functions to adjust the image by processing the image data generated by the image capturing device. For example, image adjusting device 120 functions to stabilize the captured image having defects caused by the motion of the image capturing device, especially the shake and jitter of the image capturing device. The Image adjusting device can implement different adjustments to stabilize the captured image, such as translation, rotation and zooming. However, the functionality of the image adjustment device is not limited to image stabilization, but may include image sharpening, noise filtering, contrast enhancement, image color correction and so on. For a video surveillance system, the image adjustment may be applied to both stored video clips and on live video.

Image adjustment-recording device 130 functions to record the adjustment of the image implemented by image adjusting device 120 and generate at least one image attachment associated with the image and corresponding to the adjustment. Image adjustment-recording device 130 utilizes the adjustment the image processing system computes for processing the image to render that adjustment as an image attachment corresponding to the adjustment. The image attachment generated by image adjustment-recording device 130 could be a visual indicator or metadata, associated with the image and corresponding to the adjustment. The metadata could be in the form of an XML (eXtended Markup Language) text structure associated with the image. This association between a particular image and its associated metadata can be maintained by a variety of methods known in the art. For example, the JFIF file format commonly used to represent JPEG images makes allowance for inclusion of additional metadata within the file. Streaming protocols such as RTSP allow for the establishment of multiple data streams, which in this case allows for an image stream to be transmitted on a separate logical stream from its metadata, but associated with the same streaming session.

As the image adjustment history is recorded and reflected by the image attachment, it is feasible to track the adjustments made to the image by checking the attachment corresponding to the adjustment. This ensures that any adjustments applied to the image are captured in the adjusted image output. The visual indicator and/or metadata make it clear if the image capturing device is steady or shaking, the extent of any shake, and the state of the stabilization processing. For example, in a video surveillance system, the captured images usually need to be processed for a later forensic video analysis. If the image has been accidentally adjusted, the attachment generated by the image adjustment device provides a clear clue of what adjustment has been made and a further adjustment can be implemented to reverse the previous adjustment to provide a desirable image. Image processing system 100 further comprises an image output device 140, which functions to output the adjusted image and the visual indicator overlaid on the adjusted image. In a typical surveillance system, the process of image output includes image storage and/or image viewing in real time. Whether viewed in real time or from storage, the present invention includes the option of rendering the visual indicator based on the adjustment metadata stored along with the image.

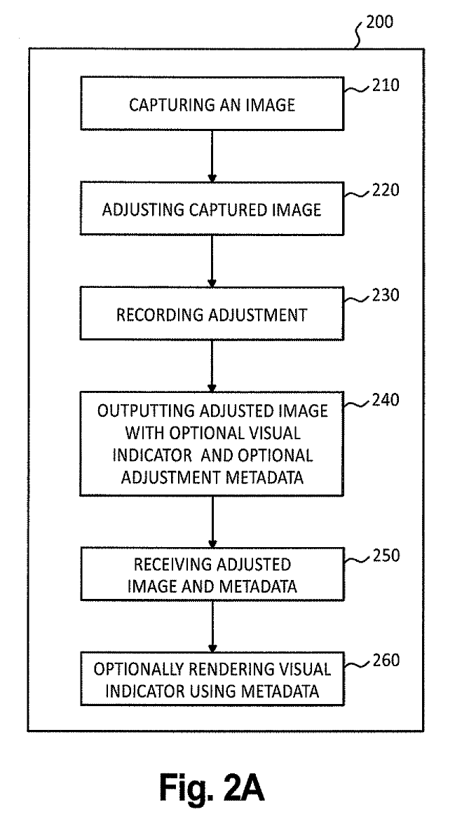

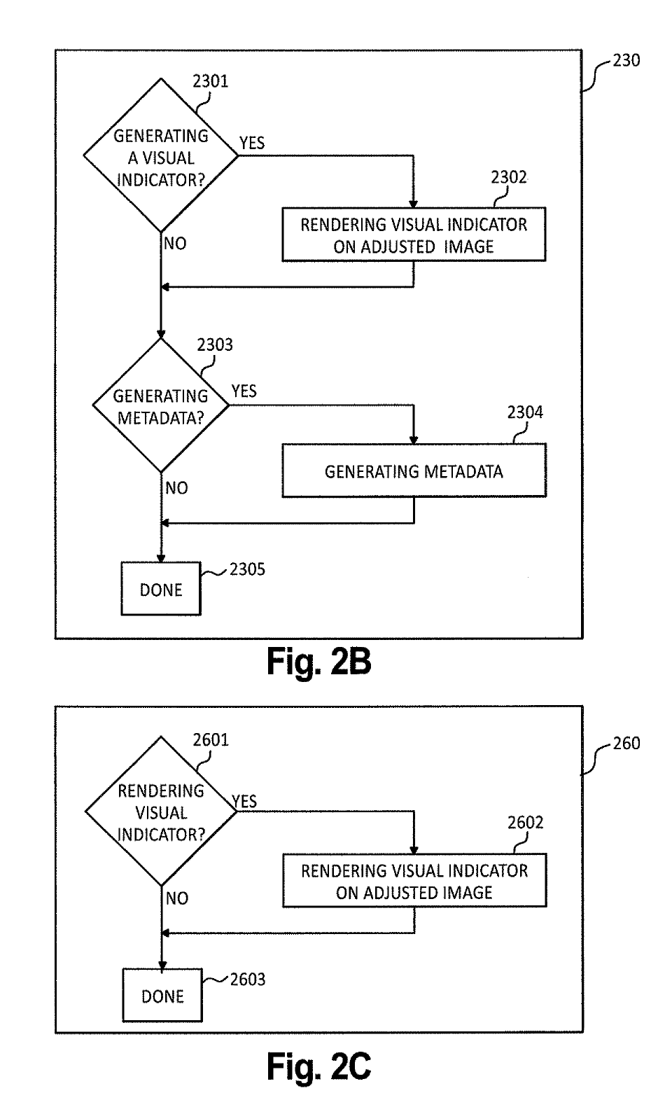

FIG. 2A-2C are flow charts illustrating an image processing method according to the present invention wherein an image attachment is generated corresponding to the image adjustment, which could be a visual indicator, metadata or both.

In FIG. 2A showing the main flow, the image processing method is indicated as 200, such as a method used to stabilize an image captured from a surveillance camera. At step 210, an image is captured and image data of the image is generated by image capturing device 110 in FIG. 1. At step 220, the captured image is adjusted by image adjusting device 120, for example, to stabilize the captured image. At step 230, the adjustment made to the image is recorded by image adjustment-recording device 130. Image adjustment-recording device 130 in FIG. 1 implements its function of generating an image attachment associated with the adjusted image and corresponding to the adjustment. FIG. 2B illustrates in detail step 230 in FIG. 2A, in which a visual indicator and/or metadata corresponding to the adjustment are generated to record the adjustment. At step 2301, it is determined whether a visual indicator be generated by image adjustment-recording device 130 according to the current system configuration. If it is determined that a visual indicator be generated to indicate the image adjustment, the method proceeds to step 2302, at which the visual indicator is generated and overlaid on the adjusted image outputted at step 240. The method subsequently proceeds to step 2303, at which it is determined whether metadata be generated by the image adjustment-recording device. If it is determined that metadata be generated, the method proceeds to step 2304, at which metadata is generated.

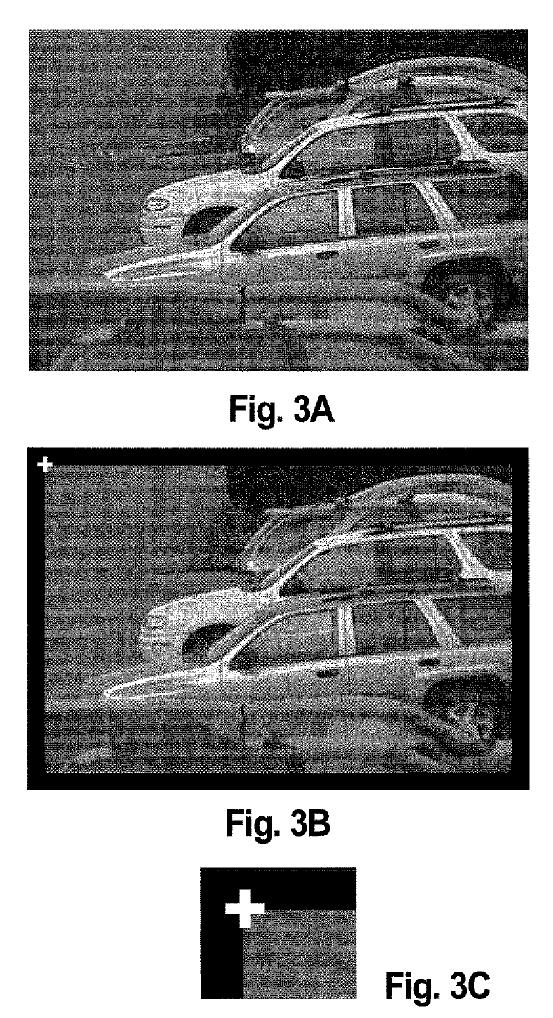

At step 240, the adjusted image is outputted and displayed with the optional visual indicator and metadata by image output device 140 shown in FIG. 1. If a visual indicator is generated corresponding to the adjustment, the information concerning the type and extent of the adjustment can be retrieved by recognizing the visual indicator corresponding to the adjustment. The visual indicator may have various configurations and physical characteristics to reflect the various adjustment of the image. Detailed description of the visual indicator will be made in connection with FIGS. 3-5.

If metadata is generated corresponding to the adjustment, the adjusted image and the metadata can be received at step 250 and the metadata can be utilized to optionally render a visual indicator at step 260. The outputted metadata can further be utilized to analyze the image adjustment or to control other functionalities of the image processing system.

FIG. 2C illustrates in detail the step 260, at which the metadata generated corresponding to the image adjustment is utilized to optionally render a visual indicator. At step 2601, it is determined whether a visual indicator be rendered by the metadata. If so, the method proceeds to step 2602, at which a visual indicator is rendered by using the information of the metadata and overlaid on the adjusted image.

This metadata approach supports flexible display options for optionally rendering a visual indictor by using the metadata. When the visual indicator is not required or when the visual indicator obscures part of the image that needs to be examined, the visual indicator can be disabled. This metadata approach also simplifies automated analysis of the adjustment information, for example, to automatically render a portion of an image in its unadjusted state. Further, the metadata approach also has the advantage of not being subject to artifacts that can be introduced by compression of a visual indicator.

FIGS. 3-5 illustrate different embodiments of the visual indicator overlaid on the output image to display the type and/or extent of the image adjustment. In these embodiments, the image processing system stabilizes the captured image to correct image defects caused by the shake of a surveillance camera.

For example, the adjustment applied in the image stabilization process is a translation of the image horizontally and vertically to within ⅛ of a pixel. The visual indicator is, for example, a crosshair disposed close to the upper left corner of the adjusted image, as shown in FIGS. 3c, 4c, and 5c. The crosshair indicates the extent of translation to the nearest pixel (e.g. a translation of less than ½ a pixel is rounded down to 0, while a translation of ½ a pixel is rounded up to 1). The image can be substantially restored to its unadjusted position by translating the image back so that the crosshair returns to its nominal position. Further, the visual indicator may have different physical characteristics to reflect the type, extent or any other properties of the adjustments during the image stabilization. For example, the visual indicator has different colors and shapes to display basic stabilization state information. The color green may be used to indicate no adjustment was made in either direction, and serves also to highlight the nominal position of the crosshair. The color yellow may be used to indicate that an adjustment was made. The color red may be used to indicate that the stabilization processing was unable to determine the degree of the translation to apply, because, for example, the image was too blurry or the field of view of the camera was changing, in which case no adjustment is made. Typical image stabilization processing applies adjustments to within a fraction of a pixel, therefore as a further refinement, the visual indicator can include an additional scale for each adjustment axis to indicate the extent of sub-pixel adjustment.

FIGS. 3a-3c illustrate a first embodiment of the visual indicator. The original image, which is unadjusted, is shown in FIG. 3a. The adjusted image is shown in FIG. 3b, in which a visual indicator is shown at the upper left corner of the figure. In FIG. 3b, the fixed black border around the adjusted image is used to avoid the visually distracting effect of a changing border due to shake. FIG. 3c is an enlarged view of the upper left corner of FIG. 3b containing the visual indicator. The visual indicator is, for example, a crosshair. For example, a green crosshair indicates that the input image was stable and no adjustment was made.

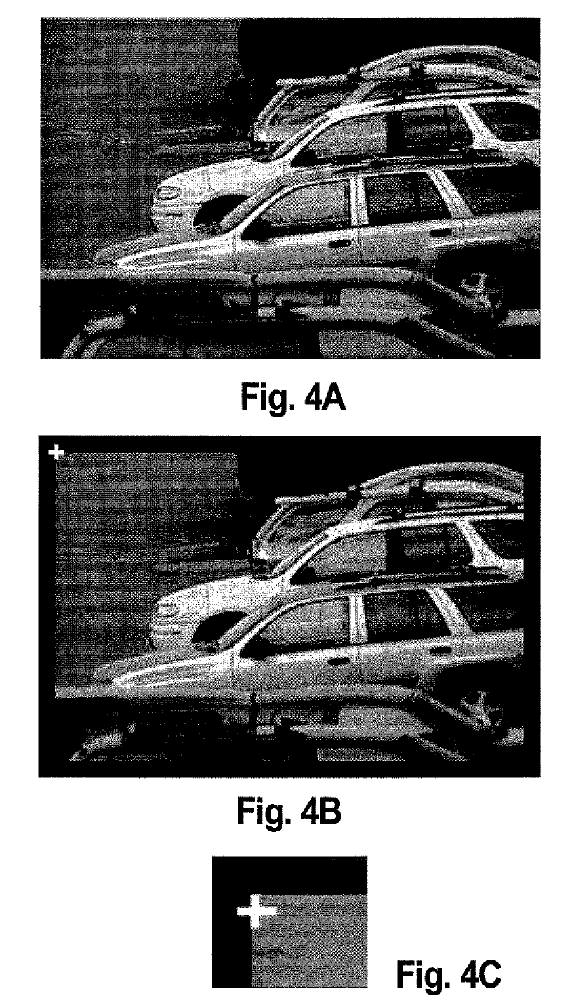

FIGS. 4a-4c illustrate a second embodiment of the visual indicator. In this embodiment, due to camera shake, the input image has shifted down slightly and to the right. The shake has also induced some blurring of the image. For example, a yellow crosshair in the adjusted image indicates that the image was translated and its position relative to the nominal position shows that the input image was adjusted up by 1 pixels and left by 4 pixel to accommodate. The adjustment metadata would indicate that the exact adjustment was 1.25 pixels up and 3.75 pixels to the left.

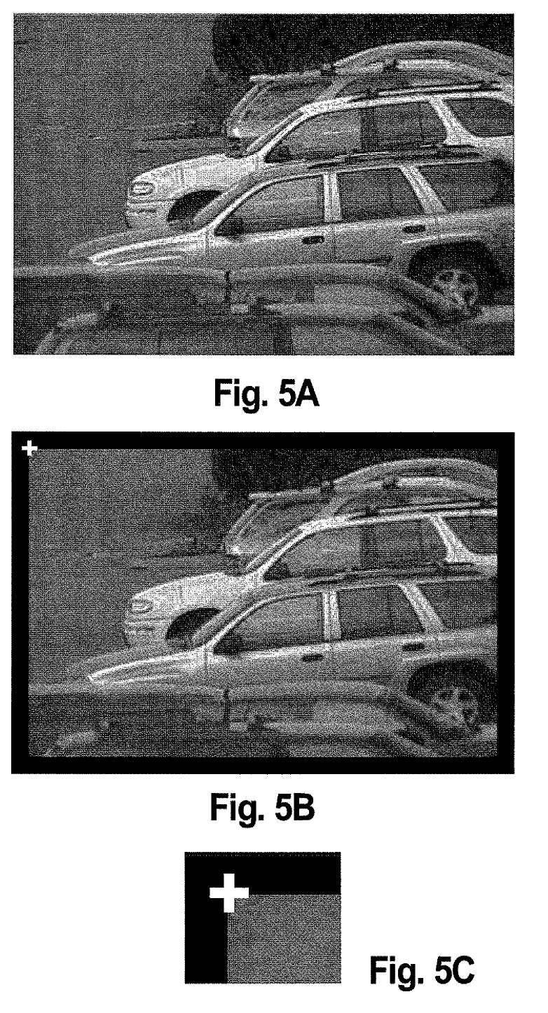

FIGS. 5a-5c illustrate a third embodiment of the visual indicator. In this embodiment, the camera has begun to zoom in. The stabilization process determines that applying any translation is not appropriate, which could be indicated by using a red crosshair in the nominal position, and by indicating in the metadata that stabilization was temporarily disabled.

In addition, the present invention is also applicable to the circumstances where the image contains a moving vehicle against an almost featureless background. In this case, the image stabilization process momentarily mistakes the vehicle motion for shake, adjusting the image to keep the vehicle stationary. A crosshair can be used to indicate that the input image was adjusted, while metadata can be used to indicate more exactly the nature of the adjustment. The effect of this erroneous correction is to make it appear that the camera is beginning a pan/tilt motion. However, since the adjustment is recorded and indicated by the visual indicator, this problem can be simply corrected by translating the output image such that the crosshair moves back to the nominal position

The invention has been described herein with reference to particular exemplary embodiments. Certain alterations and modifications may be apparent to those skilled in the art, without departing from the scope of the invention. For example, although the visual indicator has been described relative to the vertical and/or horizontal translation of the image, the visual indicator can also indicate other adjustments made to the image, such as rotation and zooming. Thus, the exemplary embodiments are meant to be illustrative, not limiting of the scope of the invention, which is defined by the appended claims.

What is claimed is:

1. An image processing system, comprising:
an image capturing device, for capturing an image and generating image data of the image;
an image adjusting device, for adjusting the image by processing the image data; and
an image adjustment-recording device, for recording the adjustment of the image implemented by the image adjusting device and generating at least one image attachment associated with the image and corresponding to the adjustment.

2. The image processing system of claim 1, wherein the image adjustment device processes the image data to stabilize the captured image by correcting image defects caused by the shake of the image capturing device.

3. The image processing system of claim 2, wherein the image adjustment device applies an affine transformation to the captured image.

4. The image processing system of claim 1, wherein the image adjustment device adjusts the captured image to implement image sharpening, noise filtering, contrast enhancement, and/or image color correction.

5. The image processing system of claim 1, wherein the image attachment generated by the image adjustment-recording device comprises a visual indictor associated with the adjusted image and corresponding to the image adjustment.

6. The image processing system of claim 5, further comprising an image output device, for outputting and displaying the image adjusted by the image adjusting device and the visual indicator.

7. The image processing system of claim 5, wherein the visual indicator comprises at least one scale indicating the extent of the image adjustments to subpixel accuracy.

8. The image processing system of claim 5, wherein the visual indicator comprises physical characteristics corresponding to the image adjustment.

9. The image processing system of claim 8, wherein the physical characteristics of the visual indicator comprise colors and/or shapes indicating different image adjustments.

10. The image processing system of claim 1, wherein the image attachment generated by the image adjustment-recording device comprises metadata associated with the adjusted image and corresponding to the image adjustment.

11. The image processing system of claim 10, wherein the metadata comprises metadata in the form of an XML text structure.

12. The image processing system of claim 10, wherein the metadata is operable to control the analysis of the adjusted image.

13. The image processing system of claim 10, wherein the metadata is operable to render a visual indicator.

14. The image processing system of claim 1, wherein the image attachment generated by the image adjustment-recording device comprises a visual indicator and metadata, both associated with the adjusted image and corresponding to the image.

15. An image processing method, comprising the steps of:
capturing an image and generating image data corresponding to the captured image;
adjusting the captured image by processing the image data; and
recording the adjustment of the image and generating an image attachment associated with the image and corresponding to the adjustment.

16. The image processing method of claim 15, wherein recording the adjustment of the image and generating an image attachment associated with image and corresponding to the adjustment comprises generating a visual indictor associated with the image and corresponding to the image adjustment.

17. The image processing method of claim 16, further comprising outputting and displaying the imaged adjusted by the image adjusting device and the visual indicator associated with the adjusted image and corresponding to the image adjustment.

18. The image processing method of claim 15, wherein recording the adjustment of the image and generating an image attachment associated with image and corresponding to the adjustment comprises generating metadata associated with the image and corresponding to the image adjustment.

19. The image processing method of claim 18, further comprising utilizing the metadata to render a visual indicator.

20. A computer program product, comprising:
a tangible storage medium readable by a processing circuit and storing instructions for execution by the processing circuit for performing an image processing method comprising the steps of:
capturing an image and generating image data corresponding to the captured image;
adjusting the captured image by processing the image data; and
recording the adjustment of the image and generating an image attachment associated with image and corresponding to the adjustment.
